(19) United States
(12) Patent Application Publication
(10) Pub. No.: US 2021/0225230 A1
(43) Pub. Date: Jul. 22, 2021

(54) DRIVING CIRCUIT

(71) Applicant: WUHAN CHINA STAR OPTOELECTRONICS TECHNOLOGY CO., LTD., Wuhan, Hubei (CN)

(72) Inventors: Xin ZHANG, Wuhan, Hubei (CN); Juncheng XIAO, Wuhan, Hubei (CN); Chao TIAN, Wuhan, Hubei (CN); Yanqing GUAN, Wuhan, Hubei (CN)

(21) Appl. No.: 16/308,125

(22) PCT Filed: Aug. 10, 2018
(86) PCT No.: PCT/CN2018/099794

§ 371 Date: Dec. 7, 2018

(30) Foreign Application Priority Data
Jul. 27, 2018 (CN) 201810843370.X

(51) Int. Cl. G09G 3/20

(52) U.S. Cl. CPC G09G 3/20; G09G 2300/043; G09G 2310/0267

(57) ABSTRACT

A driving circuit includes a driving unit. Each of the driving unit includes a body portion and a voltage-level maintaining portion, connected to the first sub-line and the second sub-line of the body portion. The voltage-level maintaining portion includes a transistor having a controlling terminal connected to the first sub-line, an input terminal connected to a first voltage-level signal input terminal of the body portion, and an output terminal connected to the second sub-line. The present disclosure can enhance the stability of the driving circuit over the display period and the touch sensing period.

### BACKGROUND

### 1. Field of the Disclosure

The present disclosure relates to the field of display, and more particularly, to a driving circuit.

### 2. Description of the Related Art

A gate driver on array (GOA) circuit is an important part of a display panel. The GOA technology is a technique for performing row by row scanning (driving) of a display panel by forming a row scanning driving signal circuit on an array substrate of the display panel in the manufacturing process of a thin film transistor (TFT) of the related art.

In the display panel integrated with a touch function, the period over which the GOA circuit drives the display panel includes a display period and a touch sensing period. Screen split easily occurs to the display panel with the GOA circuit of the related art over the touch sensing period.

Therefore, it is necessary to propose a new technical plan to solve the above-mentioned problem.

### SUMMARY

An aim of the present disclosure is to propose a driving circuit which is very stable over the display period and over the touch sensing period. Screen split will not occur to a display panel with the proposed driving circuit.

According to a first aspect of the present disclosure, a driving circuit comprises two or more driving units. Each, of the two or more driving units comprises a body portion and a voltage-level maintaining portion. A predetermined line of the body portion comprises a first sub-line and a second sub-line. The voltage-level maintaining portion is connected to the first sub-line and the second sub-line, and is configured to maintain a voltage level of the second sub-line. The voltage-level maintaining portion comprises a transistor. A controlling terminal of the transistor is connected to the first sub-line. An input terminal of the transistor is connected to a first voltage-level signal input terminal of the body portion. An output terminal of the transistor is connected to the second sub-line. The transistor is configured to receive a first voltage-level signal through the input terminal to provide the second sub-line with the first voltage-level signal when a current channel between the input terminal of the transistor and the output terminal of the transistor is opened so as to maintain the voltage level of the second sub-line. The body portion further comprises a first switch, a second switch, a first controlling signal input terminal, a second controlling signal input terminal, a first scanning signal input terminal, and a second scanning signal input terminal. A first controlling terminal of the first switch, a first input terminal of the first switch, and a first output terminal of the first switch are connected to the first scanning signal input terminal, the first controlling signal input terminal, and the first sub-line, respectively. A second controlling terminal of the second switch, a second input terminal of the second switch, and a second output terminal of the second switch are connected to the second scanning signal input terminal, a second controlling signal input terminal, and the first sub-line, respectively.

According to an embodiment of the present disclosure, the controlling terminal of the transistor is configured to receive a signal from the first output terminal and/or the second output terminal periodically to open a current channel between the input terminal and the output terminal periodically. Accordingly, the second sub-line periodically obtains a first voltage-level signal from the first voltage-level signal input terminal.

According to an embodiment of the present disclosure, the transistor is further configured to prevent a current on the second sub-line from leaking from the first switch and/or the second switch.

According to a second aspect of the present disclosure, a driving circuit comprises two or more driving units. Each of the two or more driving units comprises a body portion and a voltage-level maintaining portion. A predetermined line of the body portion comprises a first sub-line and a second sub-line. The voltage-level maintaining portion is connected to the first sub-line and the second sub-line, and is configured to maintain a voltage level of the second sub-line. The voltage-level maintaining portion comprises a transistor. A controlling terminal of the transistor is connected to the first sub-line. An input terminal of the transistor is connected to a first voltage-level signal input terminal of the body portion. An output terminal of the transistor is connected to the second sub-line.

According to an embodiment of the present disclosure, the transistor is configured to receive a first voltage-level signal through the input terminal to provide the second sub-line with the first voltage-level signal when a current channel between the input terminal of the transistor and the output terminal of the transistor is opened so as to maintain the voltage level of the second sub-line.

According to an embodiment of the present disclosure, the body portion further comprises a first switch, a second switch, a first controlling signal input terminal, a second controlling signal input terminal, a first scanning signal input terminal, and a second scanning signal input terminal. A first controlling terminal of the first switch, a first input terminal of the first switch, and a first output terminal of the first switch are connected to the first scanning signal input terminal, the first controlling signal input terminal, and the first sub-line, respectively. A second controlling terminal of the second switch, a second input terminal of the second switch, and a second output terminal of the second switch are connected to the second scanning signal input terminal, a second controlling signal input terminal, and the first sub-line, respectively.

According to an embodiment of the present disclosure, the controlling terminal of the transistor is configured to receive a signal from the first output terminal and/or the second output terminal periodically to open a current channel between the input terminal and the output terminal periodically. Accordingly, the second sub-line periodically obtains a first voltage-level signal from the first voltage-level signal input terminal.

According to an embodiment of the present disclosure, the transistor is further configured to prevent a current on the second sub-line from leaking from the first switch and/or the second switch.

According to an embodiment of the present disclosure, the body portion further comprises a third switch, a fourth switch, a first clock signal input terminal, and a second clock signal input terminal. A third controlling terminal of the third switch and a third input terminal of the third switch are connected to the first controlling signal input terminal and the first clock signal input terminal, respectively. A fourth controlling terminal of the fourth switch and a fourth input terminal of the fourth switch are connected to the second controlling signal input terminal and the second clock signal input terminal, respectively. A first clock signal transmitted by the first clock signal input terminal and/or a second clock signal transmitted by the second clock signal input terminal are configured to cooperate with a voltage-level maintaining portion so as to improve stability of the voltage level of the second sub-line.

According to an embodiment of the present disclosure, a first scan direction controlling signal received by the first controlling signal input terminal is configured to turn the third switch on or off. A second scan direction controlling signal received by the second controlling signal input terminal is configured to turn the fourth switch on or off.

According to an embodiment of the present disclosure, a scan direction which the second scan direction controlling signal corresponds to is opposite to a scan direction which the first scan direction controlling signal corresponds to.

According to an embodiment of the present disclosure, the body portion further comprises a fifth switch, a sixth switch, a seventh switch, an eighth switch, a ninth switch, a tenth switch, a scanning signal output terminal, a second voltage-level signal input terminal, a third voltage-level signal input terminal, a fourth voltage-level signal input terminal, a third clock signal input terminal, and a first capacitor. The second sub-line is connected to a seventh input terminal of the seventh switch. A fifth controlling terminal of the fifth switch is connected to an eighth output terminal of the eighth switch and a sixth output terminal of the sixth switch. A fifth input terminal of the fifth switch is connected to a second voltage-level signal input terminal. A fifth output terminal of the fifth switch is connected to a seventh input terminal of the seventh switch. A sixth controlling terminal of the sixth switch is connected to a second output terminal of the second switch. A sixth input terminal is connected to the second voltage-level signal input terminal. A seventh controlling terminal of the seventh switch is connected to the third voltage-level signal input terminal; a seventh output terminal of the seventh switch is connected to a ninth controlling terminal of the ninth switch. An eighth controlling terminal of the eighth switch is connected to the third output terminal of the third switch and a fourth output terminal of the fourth switch; an eighth input terminal of the eighth switch is connected to the fourth voltage-level signal input terminal. A ninth input terminal of the ninth switch is connected to a third clock signal input terminal; a ninth output terminal of the ninth switch is connected to a scanning signal output terminal. A tenth controlling terminal of the tenth switch is connected to the eighth output terminal of the eighth switch. A tenth input terminal of the tenth switch is connected to the second voltage-level signal input terminal; a tenth output terminal of the tenth terminal is connected to the scanning signal output terminal. A first electrode of the first capacitor is connected to a second voltage-level signal input terminal; a second electrode of the first capacitor is connected to the fifth controlling terminal.

According to an embodiment of the present disclosure, the second voltage-level signal input terminal is configured to receive a second voltage-level signal. A fifth controlling terminal of the fifth switch is configured to receive a fourth voltage-level signal output by the eighth output terminal of the eighth switch and a second voltage-level signal output by a sixth output terminal of the sixth switch. The fourth voltage-level signal and the second voltage-level signal are both configured to turn the fifth switch on or off. A sixth controlling terminal of the sixth switch is configured to receive a second scan direction controlling signal outputted by the second output terminal of the second switch. The second scan direction controlling signal is configured to turn the sixth switch on or off. A sixth input terminal of the sixth switch is configured to receive the second voltage-level signal. The third voltage-level signal input terminal is configured to receive a third voltage-level signal. The third voltage-level signal is configured to turn the seventh switch on or off. The fourth voltage-level signal input terminal is configured to receive a fourth voltage-level signal. A first clock signal outputted by a third output terminal of the third switch and a second clock signal outputted by a fourth output terminal of the fourth switch are configured to turn the eighth switch on or off. A first voltage-level signal outputted by a seventh output terminal of the seventh switch is configured to turn the ninth switch on or off. A fourth voltage-level signal outputted by the eighth output terminal of the eighth switch is configured to turn the tenth switch on or off.

According to an embodiment of the present disclosure, the tenth controlling terminal is further connected to a second electrode of the first capacitor.

According to an embodiment of the present disclosure, the body portion further comprises a second capacitor and a fifth voltage-level signal input terminal. A third electrode of the second capacitor is connected to the second sub-line. A fourth electrode of the second capacitor is connected to a fifth voltage-level signal input terminal.

According to an embodiment of the present disclosure, the body portion further comprises a third capacitor and a sixth voltage-level signal input terminal. A fifth electrode of the third capacitor is connected to the first output terminal of the first switch. A sixth electrode of the third capacitor is connected to the sixth voltage-level signal input terminal. The third capacitor is configured to improve stability of the voltage level of the second sub-line.

According to an embodiment of the present disclosure, the body portion further comprises a fourth capacitor. A seventh electrode of the fourth capacitor is connected to the ninth controlling terminal. An eighth electrode of the fourth capacitor is connected to the ninth output terminal. The fourth capacitor is configured to boost a voltage level input to the ninth controlling terminal.

According to an embodiment of the present disclosure, the body portion further comprises an eleventh switch, a twelfth switch, a thirteenth switch, a third controlling signal input terminal, and a fourth controlling signal input terminal. An eleventh controlling terminal and an eleventh controlling terminal are both connected to the third controlling signal input terminal. The eleventh output terminal of the eleventh switch is connected to the scanning signal output terminal. A twelfth controlling terminal of the twelfth switch is connected to the third controlling signal input terminal. A twelfth input terminal of the twelfth switch is connected to the second voltage-level signal input terminal. A twelfth output terminal of the twelfth switch is connected to is connected to the tenth controlling terminal. A thirteenth controlling terminal of the thirteenth switch is connected to the fourth controlling signal input terminal. A thirteenth input terminal of the thirteenth switch is connected to the second voltage-level signal input terminal; a thirteenth output terminal of the thirteenth switch is connected to the scanning signal output terminal.

According to an embodiment of the present disclosure, the third controlling signal input terminal is configured to receive a third switch controlling signal. A combination of the eleventh switch and the twelfth switch is configured to control to switches of all pixels in a pixel row which the driving unit corresponds to be turned on.

According to an embodiment of the present disclosure, the fourth controlling signal input terminal is configured to receive a fourth switch controlling signal. The thirteenth switch is configured to control switches of all pixels in a pixel row which the driving unit corresponds to be turned off.

Compared with the related art, the driving circuit of the present disclosure is provided with a voltage-level maintaining portion. The voltage-level maintaining portion includes a transistor. The transistor includes a controlling terminal connected to a first sub-line and an output terminal connected to a second sub-line. Therefore, a second node of the second sub-line can be maintained at a high voltage level, thereby enhancing the stability of the driving circuit over the display period and the touch sensing period, and preventing screen split from occurring to the display panel, that is, avoiding the risk of suspension and screen split of the display panel.

These and other features, aspects and advantages of the present disclosure will become understood with reference to the following description, appended claims and accompanying figures.

### BRIEF DESCRIPTION OF THE DRAWINGS

FIG. 1 is a circuit diagram illustrating the driving circuit according to a first embodiment of the present disclosure.

FIG. 2 is a circuit diagram illustrating the driving circuit according to a second embodiment of the present disclosure.

FIG. 3 is a circuit diagram illustrating the driving circuit according to a third embodiment of the present disclosure.

FIG. 4 is a waveform diagram illustrating a signal at a first clock signal input terminal, a second clock signal input terminal, a second clock signal input terminal, a first scanning signal input terminal, a second scanning signal input terminal, a first node, a second node, a third node, a fourth node, and a scanning signal output terminal.

### DESCRIPTION OF THE EMBODIMENTS

In the description of this specification, the description of the terms “one embodiment”, “some embodiments”, “examples”, “specific examples”, or “some examples”, and the like, means to refer to the specific feature, structure, material or characteristic described in connection with the embodiments or examples being included in at least one embodiment or example of the present disclosure. In the description of the present disclosure, the meaning of “plural” is two or more, unless otherwise specifically defined.

A driving circuit proposed by the present disclosure can be applied to a thin film transistor liquid crystal display (TFT-LCD), an organic light emitting diode (OLED), etc.

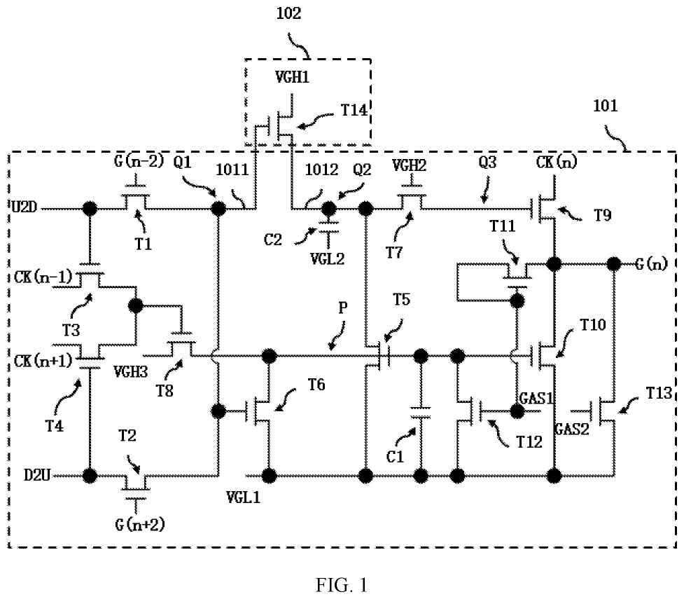

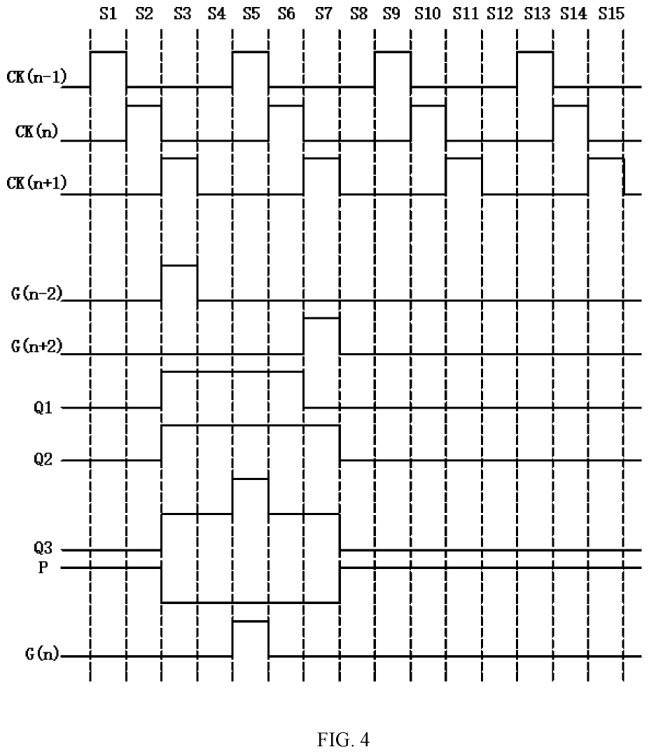

Please refer to FIG. 1 and FIG. 4. FIG. 1 is a circuit diagram illustrating the driving circuit according to a first embodiment of the present disclosure. FIG. 4 is a waveform diagram illustrating a signal at a first clock signal input terminal CK(n−1), a second clock signal input terminal CK(n+1), a second clock signal input terminal CK(n+1), a first scanning signal input terminal G(n−2), a second scanning signal input terminal G(n+2), a first node Q1, a second node Q2, a third node Q3, a fourth node P, and a scanning signal output terminal G(n).

The driving circuit includes two or more driving units. The two or more driving units are arranged in an array. The two or more driving units are connected to each other. Specifically, an Nth driving circuit is connected to an (N−2)th driving circuit and an (N+2)th driving circuit. The N is an integer greater than or equal to three.

A scanning signal generated by each of the driving units is output to a pixel array of the display panel which the driving circuit corresponds to. Further, a scanning signal generated by the (N−2)th driving unit and a scanning signal generated by the (N+2)th driving unit are output to the Nth driving circuit.

The driving unit includes a body portion 101 and a voltage-level portion 102. The body portion 101 is connected to the voltage-level portion 102.

The predetermined line of the body portion 101 includes a first sub-line 1011 and a second sub-line 1012. The first sub-line 1011 and a second sub-line 1012 are disconnected (insulated).

The voltage-level maintaining portion 102 is connected to the first sub-line 1011 and the second sub-line 1012. The voltage-level maintaining portion 102 is configured to maintain the voltage level of the second sub-line 1012. The voltage-level maintaining portion 102 includes a transistor T14. The transistor T14 includes a controlling terminal, an input terminal, and an output terminal. The controlling terminal is connected to the first sub-line 1011. The input terminal is connected to a first voltage-level signal input terminal VGH1 of the body portion 101. The output terminal is connected to the second sub-line 1012. The first voltage-level signal input terminal VGH1 is configured to receive the first voltage-level signal.

The voltage-level maintaining portion 102 (the transistor T14) is configured to receive the first voltage-level signal through the input terminal to provide the second sub-line 1012 with the first voltage-level signal when a current channel between the input terminal of the transistor T14 and the output terminal of the transistor T14 is opened. In this way, the voltage level of the second sub-line 1012 is maintained.

Further, the voltage-level maintaining portion 102 (the transistor T14) is configured to prevent the current of the second sub-line 1012 from being transmitted to the first sub-line 1011. Specifically, the first sub-line 1011 and the second sub-line 1012 are disconnected because the controlling terminal of the transistor T14 and the output terminal of the transistor T14 are connected to the first sub-line 1011 and the second sub-line 1012, respectively. The current in the second sub-line 1012 cannot flow into the first sub-line 1011 through the transistor T14, so that the voltage level at the second sub-line 1012 can be effectively maintained.

Further, the body portion 101 includes a first switch T1, a second switch T2, a first controlling signal input terminal U2D, a second controlling signal input terminal D2U, a first scanning signal input terminal G(n−2), and a second scanning signal input terminal G(n+2).

The first controlling terminal of the first switch T1, the first input terminal of the first switch T1, and the first output terminal of the first switch T1 are connected to the first scanning signal input terminal G(n−2), the first controlling signal input terminal U2D, and the first sub-line 1011, respectively.

The second controlling terminal of the second switch T2, the second input terminal of the second switch T2, and the second output terminal of the second switch T2 are connected to the second scanning signal input terminal G(n+2), the second controlling signal input terminal D2U, and the first sub-line 1011, respectively.

The first controlling signal input terminal U2D is configured to receive a first scan direction controlling signal. The second controlling signal input terminal D2U is configured to receive a second scan direction controlling signal. A scan direction which the second scan direction controlling signal corresponds to is opposite to a scan direction which the first scan direction controlling signal corresponds to.

In a case where the driving unit is the Nth driving unit in the driving circuit, the first scanning signal input terminal G(n−2) is configured to receive a scanning signal (the first scanning signal) generated by the (N−2)th driving unit. The second scanning signal input terminal G(n+2) is configured to receive a scanning signal (the second scanning signal) generated by the (N+2)th driving unit.

A scanning signal (the first scanning signal) generated by the (N−2)th driving unit is configured to turn the first switch T1 on or off. A scanning signal (the second scanning signal) generated by the (N+2)th driving unit is configured to turn the second switch T2 on or off.

Please refer to FIG. 4. In a third time slot S3, the first scanning signal is at a high voltage level. From a first time slot S1 to a second time slot S2 and from a fourth time slot S4 to a fifteenth time slot S15, the first scanning signal is at a low voltage level. In a seventh time slot S7, the second scanning signal is at a high voltage level. From a first time slot S1 to a sixth time slot S6 and from an eighth time slot S8 to the fifteenth time slot S15, the second scanning signal is at a low voltage level in the first time slot S1 and the sixth time slot S6. In the fifth time slot S5, the scanning signal (the third scanning signal) outputted by the scanning signal output terminal G(n) is at a high voltage level. From the first time slot S1 to the fourth time slot S4 and from the sixth time slot S6 to the fifteenth time slot S15, the third scanning signal is at a low voltage level.

The controlling terminal of the transistor T14 is configured to receive a signal from the first output terminal and/or the second output terminal periodically to open a current channel between the input terminal and the output terminal periodically. Accordingly, the second sub-line 1012 periodically obtains the first voltage-level signal from the first voltage-level signal input terminal VGH1, which facilitates maintenance of the voltage level of the second sub-line 1012.

Further, the transistor T14 is configured to prevent a current on the second sub-line 1012 from leaking from the first switch TI and/or the second switch T2.

The first sub-line 1011 and the second sub-line 1012 are directly connected before the first sub-line 1011 and the second sub-line 1012 are connected through the voltage-level maintaining portion 102 (the transistor T14). The first switch T1 and the second switch T2 both are thin film transistors (TFTs). Because TFTs tend to leak, the current in the second sub-line 1012 is easily transmitted to the first switch T1 and/or the second switch T2 through the first sub-line 1011 and easily leaked through the first switch T1 and/or the second switch T2 at the same time. In contrast, in the present embodiment, the first sub-line 1011 and the second sub-line 1012 are connected via the voltage-level maintaining portion 102 (the transistor T14), the current in the second sub-line 1012 can be prevented from being transmitted to the first sub-line 1011 and further, the current can be prevented from leaking from the first switch T1 and/or the second switch T2.

Further, the body portion 101 includes a third switch T3, a fourth switch T4, a first clock signal input terminal CK(n−1), and a second clock signal input terminal CK(n+1).

The third controlling terminal of the third switch T3 and the third input terminal of the third switch T3 are connected to the first controlling signal input terminal U2D and the first clock signal input terminal CK(n−1), respectively. The first clock signal input terminal CK(n−1) is for receiving the first clock signal.

The fourth controlling terminal of the fourth switch T4 and the fourth input terminal of the fourth switch T4 are connected to the second controlling signal input terminal D2U and the second clock signal input terminal CK(n+1), respectively. The second clock signal input terminal CK(n+1) is for receiving the second clock signal.

The first clock signal transmitted by the first clock signal input terminal CK(n−1) and/or the second clock signal transmitted by the second clock signal input terminal CK(n+1) are configured to cooperate with the voltage-level maintaining portion 102 so as to improve the stability of the voltage level of the second sub-line 1012. As illustrated in FIG. 4, in the first time slot S1, the fifth time slot S5, the ninth time slot S9, and the thirteenth time slot S13, the first clock signal is at a high voltage level. From the second time slot S2 to the fourth time slot S4, from a sixth time slot S6 to an eighth time slot S8, from a tenth time slot S10 to a twelfth time slot S12, and from a fourteenth time slot S14 to a fifteenth time slot S15, the first clock signal is at a low level. In the third time slot S3, the seventh time slot S7, the eleventh time slot S11, and the fifteenth time slot S15, the second clock signal is at a high voltage level. From the first time slot S1 to the second time slot S2, from the fourth time slot S4 to the sixth time slot S6, the eighth time slot S8 to the tenth time slot S10, the twelfth time slot S12 to the fourteenth time slot S14, and the second clock signal is at a low voltage level.

The first scan direction controlling signal received by the first controlling signal input terminal U2D is configured to turn the third switch T3 on or off. The second scan direction controlling signal received by the second controlling signal input terminal D2U is configured to turn the fourth switch T4 on or off.

Further, the body portion 101 includes a fifth switch T5, a sixth switch T6, a seventh switch T7, an eighth switch T8, a ninth switch T9, a tenth switch T10, a scanning signal output terminal G(n), a second voltage-level signal input terminal VGL1, a third voltage-level signal input terminal VGH2, a fourth voltage-level signal input terminal VGH3, a third clock signal input terminal CK(n), and a first capacitor C1.

The second sub-line 1012 is connected to the seventh input terminal of the seventh switch T7.

The fifth switch T5 includes a fifth controlling terminal, a fifth input terminal, and a fifth output terminal. The fifth controlling terminal of the fifth switch T5 is connected to an eighth output terminal of the eighth switch T8 and a sixth output terminal of the sixth switch T6. The fifth input terminal of the fifth switch T5 is connected to the second voltage-level signal input terminal VGL1. The fifth output terminal of the fifth switch T5 is connected to the seventh input terminal of the seventh switch T7. The second voltage-level signal input terminal VGL1 is configured to receive the second voltage-level signal. The fifth controlling terminal of the fifth switch T5 is configured to receive the fourth voltage-level signal output by the eighth output terminal of the eighth switch T8 and the second voltage-level signal output by the sixth output terminal of the sixth switch T6. The fourth voltage-level signal and the second voltage-level signal are both configured to turn the fifth switch T5 on or off.

The sixth switch T6 includes a sixth controlling terminal and a sixth input terminal. The sixth controlling terminal is connected to a second output terminal of the second switch T2. The sixth input terminal is connected to a second voltage-level signal input terminal VGL1. The sixth controlling terminal is configured to receive a second scan direction controlling signal outputted by the second output terminal of the second switch T2. The second scan direction controlling signal is configured to turn the sixth switch T6 on or off. The sixth input terminal is configured to receive the second voltage-level signal.

The seventh switch T7 includes a seventh controlling terminal and a seventh output terminal, and an input terminal. The seventh controlling terminal is connected to a third voltage-level signal input terminal VGH2. The seventh output terminal is connected to a ninth controlling terminal of the ninth switch T9. The seventh input terminal is connected to the second sub-line 1012 and a first electrode of the second capacitor C2. The third voltage-level signal input terminal VGH2 is configured to receive the third voltage-level signal. The third voltage-level signal is configured to turn the seventh switch T7 on or off.

The eighth switch T8 includes an eighth controlling terminal and an eighth input terminal. The eighth controlling terminal is connected to the third output terminal of the third switch T3 and the fourth output terminal of the fourth switch T4. The eighth input terminal is connected to the fourth voltage-level signal input terminal VGH3. The fourth voltage-level signal input terminal VGH3 is configured to receive the fourth voltage-level signal. A first clock signal outputted by the third output terminal of the third switch T3 and a second clock signal outputted by the fourth output terminal of the fourth switch T4 are configured to turn the eighth switch T8 on or off.

The ninth switch T9 includes a ninth input terminal and a ninth controlling terminal. The ninth input terminal is connected to a third clock signal input terminal CK(n). The ninth output terminal is connected to a scanning signal output terminal G(n). The first voltage-level signal outputted by the seventh output terminal of the seventh switch T7 is configured to turn the ninth switch T9 on or off. As illustrated in FIG. 4, in the second time slot S2, the sixth time slot S6, the tenth time slot S10, and the fourteenth time slot S14, the third clock signal is at a high voltage level. In the first time slot S1, from a third time slot S3 to a fifth time slot S5, from a seventh time slot S7 to a ninth time slot S9, from an eleventh time slot S11 to a thirteenth time slot S13, and in a fifteenth time slot S15, the third clock signal is at a low voltage level.

The tenth switch T10 includes a tenth controlling terminal, a tenth input terminal, and a tenth output terminal. The tenth controlling terminal is connected to the eighth output terminal of the eighth switch T8. The tenth input terminal is connected to the second voltage-level signal input terminal VGL1. The tenth output terminal is connected to the scanning signal output terminal G(n). The fourth voltage-level signal outputted by the eighth output terminal of the eighth switch T8 is configured to turn the tenth switch T10 on or off.

The first electrode of the first capacitor C1 is connected to the second voltage-level signal input terminal VGL1. A second electrode of the first capacitor C1 is connected to the fifth controlling terminal.

Further, the tenth controlling terminal is connected to the second electrode of the first capacitor C1.

Further, the body portion 101 includes a second capacitor C2 and a fifth voltage-level signal input terminal VGL2. The fifth voltage-level signal input terminal VGL2 is configured to receive the fifth voltage-level signal.

A third electrode of the second capacitor C2 is connected to the second sub-line 1012. A fourth electrode of the second capacitor C2 is connected to the fifth voltage-level signal input terminal VGL2.

Further, the body portion 101 includes an eleventh switch T11, a twelfth switch T12, a thirteenth switch T13, a third controlling signal input terminal GAS1, and a fourth controlling signal input terminal GAS2.

The third controlling signal input terminal GAS1 is configured to receive a third switch controlling signal. A fourth controlling signal input terminal GAS2 is configured to receive a fourth switch controlling signal.

The eleventh switch T11 includes an eleventh controlling terminal, an eleventh input terminal, and an eleventh output terminal. The eleventh controlling terminal and the eleventh controlling terminal are both connected to the third controlling signal input terminal GAS1. The eleventh output terminal is connected to the scanning signal output terminal G(n). The third switch controlling signal is configured to turn the eleventh switch T11 on or off.

The twelfth switch T12 includes a twelfth controlling terminal, a twelfth input terminal, and a twelfth output terminal. The twelfth controlling terminal is connected to the third controlling signal input terminal GAS1. The twelfth input terminal is connected to the second voltage-level signal input terminal VGL1. The twelfth output terminal is connected to the tenth controlling terminal. The third switch controlling signal is configured to turn the twelfth switch T12 on or off.

The twelfth switch T12 and the eleventh switch T11 form a all-gate-on module, that is, a combination of the eleventh switch T11 and the twelfth switch T12. All of the pixel switches in a pixel row which the driving unit corresponds to are turned on (all gate on) under the control of the combination.

The thirteenth switch T13 includes a thirteenth controlling terminal, a thirteenth input terminal, and a thirteenth output terminal. The thirteenth controlling terminal is connected to the fourth controlling signal input terminal GAS2. The thirteenth input terminal is connected to the second voltage-level signal input terminal VGL1. The thirteenth output terminal is connected to the scanning signal output terminal G(n).

The thirteenth switch T13 form a pixel switch all gate off module (all gate off) module; that is, all of the pixel switches in a pixel row which the driving unit corresponds to are turned off (all gate on) under the control of the thirteenth switch T13.

As illustrated in FIG. 4, from the third time slot S3 to the sixth time slot S6, the signal at the first node Q1 is at a high voltage level. From the first time slot S1 to the second time slot S2 and from the seventh time slot S7 to the fifteenth time slot S15, the signal at the first node Q1 is at a low voltage level. The first node Q1 is located at the first sub-line 1011.

From the third time slot S3 to the seventh time slot S7, the signal at the second node Q2 is at a high voltage level. From the first time slot S1 to the second time slot S2 and from the eighth time slot S8 to the fifteenth time slot S15, the signal at the second node Q2 is at a low voltage level. The second node Q2 is located at the second sub-line 1012.

From the third time slot S3 to the seventh time slot S7, the signal at the third node Q3 is at a high voltage level. From the first time slot S1 to the second time slot S2, from the eighth time slot S8 to the fifteenth time slot S15, the signal at the third node Q3 is at a low voltage level. The third node Q3 is located at a circuit between the ninth controlling terminal of the ninth switch T9 and the seventh output terminal of the seventh switch T7.

From the third time slot S3 to the seventh time slot S7, the signal at the fourth node P is at a low voltage level. From the first time slot S1 to the second time slot S2, and from the eighth time slot S8 to the fifteenth time slot S15, the signal at the fourth node P is at a high voltage level. The fourth node P is located at a circuit between the eighth output terminal of the eighth switch T8 and the fifth controlling terminal of the fifth switch T5.

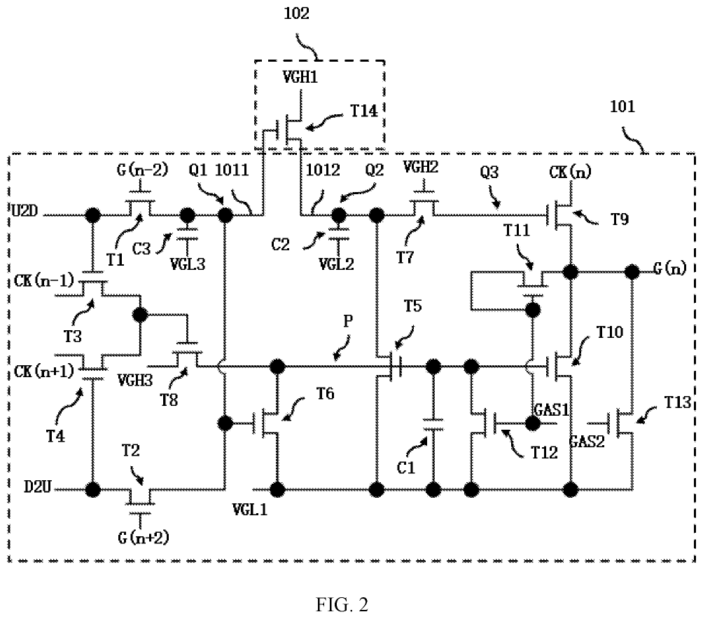

Please refer to FIG. 2. FIG. 2 is a circuit diagram illustrating a driving circuit according to a second embodiment of the present disclosure. This embodiment is similar to the first embodiment described above, except that:

In the present embodiment, a body portion 101 further includes a third capacitor C3 and a sixth voltage-level signal input terminal VGL3. A sixth voltage-level signal input terminal VGL3 is configured to receive a sixth voltage-level signal.

A fifth electrode of the third capacitor C3 is connected to a first output terminal of the first switch T1. A sixth electrode of the third capacitor C3 is connected to the sixth voltage-level signal input terminal VGL3. The third capacitor C3 is configured to improve the stability of the voltage level of a second sub-line 1012.

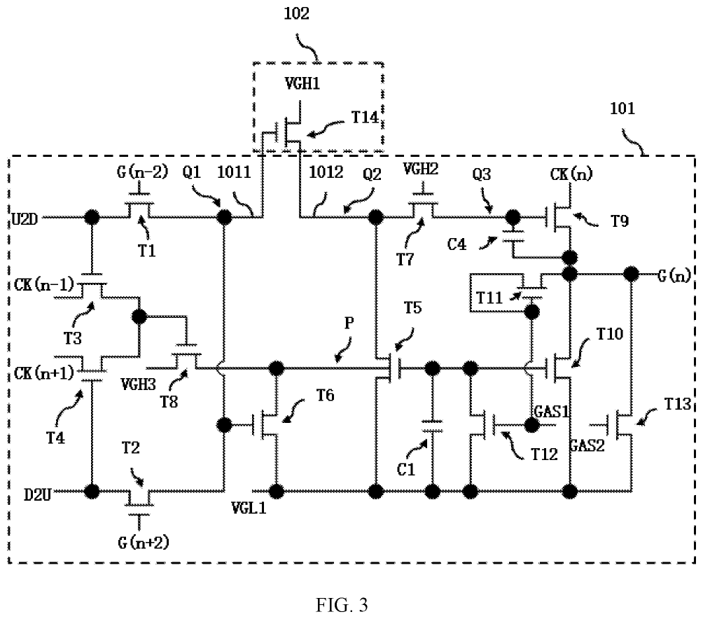

Please refer to FIG. 3. FIG. 3 is a circuit diagram of a driving circuit according to a third embodiment of the present disclosure. This embodiment is similar to the first embodiment or the second embodiment described above, except that:

In the embodiment, a body portion 101 further includes a fourth capacitor C4.

A seventh electrode of the fourth capacitor C4 is connected to a ninth controlling terminal. An eighth electrode of the fourth capacitor C4 is connected to a ninth output terminal. The fourth capacitor C4 is configured to boost a voltage level input to a ninth controlling terminal.

A voltage-level maintaining portion 102 (a transistor T14) can reduce the demand of a driving unit (an Nth driving unit) for the waveform of a scanning signal generated by an (N−2)th driving unit and received by a first scanning signal input terminal G(n−2), which enhances the reliability of row by row cascade of the driving unit (the Nth driving).

Further, for a pixel array of the display panel to which the driving circuit is applied, the influence of a scanning signal (the second scanning signal) generated by the (N+2)th driving unit received by the second scanning signal input terminal G(n+2) on cascade of the driving unit is reduced owing to the voltage-level maintaining portion 102 (the transistor T14). Accordingly, the phenomenon that image flickers on the display panel can be avoided. The reliability of row by row cascade of the driving unit (the Nth driving unit) can be enhanced as well.

Compared with the related art, the driving circuit of the present disclosure is provided with a voltage-level maintaining portion. The voltage-level maintaining portion includes a transistor. The transistor includes a controlling terminal connected to a first sub-line and an output terminal connected to a second sub-line. Therefore, a second node of the second sub-line can be maintained at a high voltage level, thereby enhancing the stability of the driving circuit over the display period and the touch sensing period, and preventing screen split from occurring to the display panel, that is, avoiding the risk of suspension and screen split of the display panel.

The above texts are merely specific embodiments of the present disclosure. However, the scope of the present disclosure is not limited hereto. Any variations or alternatives that can easily be thought of by technicians familiar with the field should fall within the scope of the present disclosure. Therefore, the scope of the present disclosure should be defined by the scope of the claims.

What is claimed is:

1. A driving circuit, comprising two or more driving units, each of the two or more driving units comprising:
a body portion, a predetermined line of the body portion comprising a first sub-line and a second sub-line;
a voltage-level maintaining portion, connected to the first sub-line and the second sub-line, configured to maintain a voltage level of the second sub-line; the voltage-level maintaining portion comprising a transistor; a controlling terminal of the transistor connected to the first sub-line; an input terminal of the transistor connected to a first voltage-level signal input terminal of the body portion; an output terminal of the transistor connected to the second sub-line,
wherein the transistor is configured to receive a first voltage-level signal through the input terminal to provide the second sub-line with the first voltage-level signal when a current channel between the input terminal of the transistor and the output terminal of the transistor is opened so as to maintain the voltage level of the second sub-line,
wherein the body portion further comprises a first switch, a second switch, a first controlling signal input terminal, a second controlling signal input terminal, a first scanning signal input terminal, and a second scanning signal input terminal;
a first controlling terminal of the first switch, a first input terminal of the first switch, and a first output terminal of the first switch are connected to the first scanning signal input terminal, the first controlling signal input terminal, and the first sub-line, respectively;
a second controlling terminal of the second switch, a second input terminal of the second switch, and a second output terminal of the second switch are connected to the second scanning signal input terminal, a second controlling signal input terminal, and the first sub-line, respectively.

2. The driving circuit of claim 1, wherein the controlling terminal of the transistor is configured to receive a signal from the first output terminal and/or the second output terminal periodically to open a current channel between the input terminal and the output terminal periodically; accordingly, the second sub-line periodically obtains a first voltage-level signal from the first voltage-level signal input terminal.

3. The driving circuit of claim 1, wherein the transistor is further configured to prevent a current on the second sub-line from leaking from the first switch and/or the second switch.

4. A driving circuit, comprising two or more driving units, each of the two or more driving units comprising:
a body portion, a predetermined line of the body portion comprising a first sub-line and a second sub-line;
a voltage-level maintaining portion, connected to the first sub-line and the second sub-line, configured to maintain a voltage level of the second sub-line; the voltage-level maintaining portion comprising a transistor; a controlling terminal of the transistor connected to the first sub-line; an input terminal of the transistor connected to a first voltage-level signal input terminal of the body portion; an output terminal of the transistor connected to the second sub-line.

5. The driving circuit of claim 4, wherein the transistor is configured to receive a first voltage-level signal through the input terminal to provide the second sub-line with the first voltage-level signal when a current channel between the input terminal of the transistor and the output terminal of the transistor is opened so as to maintain the voltage level of the second sub-line.

6. The driving circuit of claim 4, wherein the body portion further comprises a first switch, a second switch, a first controlling signal input terminal, a second controlling signal input terminal, a first scanning signal input terminal, and a second scanning signal input terminal;
a first controlling terminal of the first switch, a first input terminal of the first switch, and a first output terminal of the first switch are connected to the first scanning signal input terminal, the first controlling signal input terminal, and the first sub-line, respectively;
a second controlling terminal of the second switch, a second input terminal of the second switch, and a second output terminal of the second switch are connected to the second scanning signal input terminal, a second controlling signal input terminal, and the first sub-line, respectively.

7. The driving circuit of claim 6, wherein the controlling terminal of the transistor is configured to receive a signal from the first output terminal and/or the second output terminal periodically to open a current channel between the input terminal and the output terminal periodically; accordingly, the second sub-line periodically obtains a first voltage-level signal from the first voltage-level signal input terminal.

8. The driving circuit of claim 6, wherein the transistor is further configured to prevent a current on the second sub-line from leaking from the first switch and/or the second switch.

9. The driving circuit of claim 3, wherein the body portion further comprises a third switch, a fourth switch, a first clock signal input terminal, and a second clock signal input terminal;
a third controlling terminal of the third switch and a third input terminal of the third switch are connected to the first controlling signal input terminal and the first clock signal input terminal, respectively;
a fourth controlling terminal of the fourth switch and a fourth input terminal of the fourth switch are connected to the second controlling signal input terminal and the second clock signal input terminal, respectively;
a first clock signal transmitted by the first clock signal input terminal and/or a second clock signal transmitted by the second clock signal input terminal are configured to cooperate with a voltage-level maintaining portion so as to improve stability of the voltage level of the second sub-line.

10. The driving circuit of claim 9, wherein a first scan direction controlling signal received by the first controlling signal input terminal is configured to turn the third switch on or off; a second scan direction controlling signal received by the second controlling signal input terminal is configured to turn the fourth switch on or off.

11. The driving circuit of claim 10, wherein a scan direction which the second scan direction controlling signal corresponds to is opposite to a scan direction which the first scan direction controlling signal corresponds to.

12. The driving circuit of claim 9, wherein the body portion further comprises a fifth switch, a sixth switch, a seventh switch, an eighth switch, a ninth switch, a tenth switch, a scanning signal output terminal, a second voltage-level signal input terminal, a third voltage-level signal input terminal, a fourth voltage-level signal input terminal, a third clock signal input terminal, and a first capacitor;
the second sub-line is connected to a seventh input terminal of the seventh switch;
a fifth controlling terminal of the fifth switch is connected to an eighth output terminal of the eighth switch and a sixth output terminal of the sixth switch; a fifth input terminal of the fifth switch is connected to a second voltage-level signal input terminal; a fifth output terminal of the fifth switch is connected to a seventh input terminal of the seventh switch;
a sixth controlling terminal of the sixth switch is connected to a second output terminal of the second switch; a sixth input terminal is connected to the second voltage-level signal input terminal;
a seventh controlling terminal of the seventh switch is connected to the third voltage-level signal input terminal; a seventh output terminal of the seventh switch is connected to a ninth controlling terminal of the ninth switch;
an eighth controlling terminal of the eighth switch is connected to the third output terminal of the third switch and a fourth output terminal of the fourth switch; an eighth input terminal of the eighth switch is connected to the fourth voltage-level signal input terminal;
a ninth input terminal of the ninth switch is connected to a third clock signal input terminal; a ninth output terminal of the ninth switch is connected to a scanning signal output terminal;
a tenth controlling terminal of the tenth switch is connected to the eighth output terminal of the eighth switch; a tenth input terminal of the tenth switch is connected to the second voltage-level signal input terminal; a tenth output terminal of the tenth terminal is connected to the scanning signal output terminal;
a first electrode of the first capacitor is connected to a second voltage-level signal input terminal; a second electrode of the first capacitor is connected to the fifth controlling terminal.

13. The driving circuit of claim 12, wherein the second voltage-level signal input terminal is configured to receive a second voltage-level signal;
a fifth controlling terminal of the fifth switch is configured to receive a fourth voltage-level signal output by the eighth output terminal of the eighth switch and a second voltage-level signal output by a sixth output terminal of the sixth switch;
the fourth voltage-level signal and the second voltage-level signal are both configured to turn the fifth switch on or off;
a sixth controlling terminal of the sixth switch is configured to receive a second scan direction controlling signal outputted by the second output terminal of the second switch; the second scan direction controlling signal is configured to turn the sixth switch on or off; a sixth input terminal of the sixth switch is configured to receive the second voltage-level signal;
the third voltage-level signal input terminal is configured to receive a third voltage-level signal; the third voltage-level signal is configured to turn the seventh switch on or off;
the fourth voltage-level signal input terminal is configured to receive a fourth voltage-level signal;
a first clock signal outputted by a third output terminal of the third switch and a second clock signal outputted by a fourth output terminal of the fourth switch are configured to turn the eighth switch on or off;
a first voltage-level signal outputted by a seventh output terminal of the seventh switch is configured to turn the ninth switch on or off;
a fourth voltage-level signal outputted by the eighth output terminal of the eighth switch is configured to turn the tenth switch on or off.

14. The driving circuit of claim 12, wherein the tenth controlling terminal is further connected to a second electrode of the first capacitor.

15. The driving circuit of claim 12, wherein the body portion further comprises a second capacitor and a fifth voltage-level signal input terminal;
a third electrode of the second capacitor is connected to the second sub-line; a fourth electrode of the second capacitor is connected to a fifth voltage-level signal input terminal.

16. The driving circuit of claim 12, wherein the body portion further comprises a third capacitor and a sixth voltage-level signal input terminal;
a fifth electrode of the third capacitor is connected to the first output terminal of the first switch; a sixth electrode of the third capacitor is connected to the sixth voltage-level signal input terminal; the third capacitor is configured to improve stability of the voltage level of the second sub-line.

17. The driving circuit of claim 12, wherein the body portion further comprises a fourth capacitor;
a seventh electrode of the fourth capacitor is connected to the ninth controlling terminal;
an eighth electrode of the fourth capacitor is connected to the ninth output terminal; the fourth capacitor is configured to boost a voltage level input to the ninth controlling terminal.

18. The driving circuit of claim 9, wherein the body portion further comprises an eleventh switch, a twelfth switch, a thirteenth switch, a third controlling signal input terminal, and a fourth controlling signal input terminal;
an eleventh controlling terminal and an eleventh controlling terminal are both connected to the third controlling signal input terminal; the eleventh output terminal of the eleventh switch is connected to the scanning signal output terminal;
a twelfth controlling terminal of the twelfth switch is connected to the third controlling signal input terminal; a twelfth input terminal of the twelfth switch is connected to the second voltage-level signal input terminal; a twelfth output terminal of the twelfth switch is connected to is connected to the tenth controlling terminal;
a thirteenth controlling terminal of the thirteenth switch is connected to the fourth controlling signal input terminal; a thirteenth input terminal of the thirteenth switch is connected to the second voltage-level signal input terminal; a thirteenth output terminal of the thirteenth switch is connected to the scanning signal output terminal.

19. The driving circuit of claim 18, wherein the third controlling signal input terminal is configured to receive a third switch controlling signal;
a combination of the eleventh switch and the twelfth switch is configured to control to switches of all pixels in a pixel row which the driving unit corresponds to be turned on.

20. The driving circuit of claim 18, wherein the fourth controlling signal input terminal is configured to receive a fourth switch controlling signal;
the thirteenth switch is configured to control switches of all pixels in a pixel row which the driving unit corresponds to be turned off.
